(19) United States
(12) Patent Application Publication
(10) Pub. No.: US 2007/0068306 A1
(43) Pub. Date: Mar. 29, 2007

(54) PEDAL FORCE AUGMENTATION DEVICE

(75) Inventors: John H. Herrick, Aloha, OR (US); Scott Thiel, Sherwood, OR (US); Sean Naughton, Portland, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: WILLIAMS CONTROLS INDUSTRIES, INC., Portland, OR (US)

(21) Appl. No.: 11/535,399

(22) Filed: Sep. 26, 2006

Related U.S. Application Data
(60) Provisional application No. 60/720,929, filed on Sep. 26, 2005.

(51) Int. Cl. G06G 7/76; G05G 13/00; G06F 19/00; G05G 9/00

(52) U.S. Cl. 74/478; 701/70

(57) ABSTRACT

Embodiments of the present invention provide a pedal force augmentation device. Other embodiments may be described and claimed.

### CROSS REFERENCE TO RELATED APPLICATIONS

The present application claims priority to U.S. patent application Ser. No. 60/720,929, filed Sep. 26, 2005, entitled “Pedal Force Augmentation Device,” the entire disclosure of which is hereby incorporated by reference in its entirety.

### TECHNICAL FIELD

Embodiments of the present invention relate to the field of vehicle electronic pedal assemblies, and more particularly, to a device that augments the pedal force required for actuation.

### BACKGROUND

Electronic pedal assemblies for throttle control have been in existence for several years. Only recently are electronic pedal assemblies being used for brake systems. Because there is no feed back to the user in electronic pedal assemblies, there is a need to induce some resistance. For brake pedals, the applied brake pedal force is typically several times greater than that of an accelerator pedal, and thus increased resistance inducement is required. Typically springs and/or a number of linkage components are used to provide such resistance, and are typically mounted between the floor and the middle section of the pedal body. These systems, however, are generally cumbersome and can be a costly component of the pedal assembly. Further, such resistance mechanisms are prone to interference, and invasion by particles, debris or other contaminants, all of which can dramatically affect the pedal's function.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 is a perspective view of a pedal arrangement, in accordance with various embodiments of the present invention;

FIG. 2 is a perspective view of a pedal force augmentation device in accordance with various embodiments of the present invention; and

FIG. 3 is an exploded view of a pedal arrangement in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” nmeans “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide pedal force augmentation device.

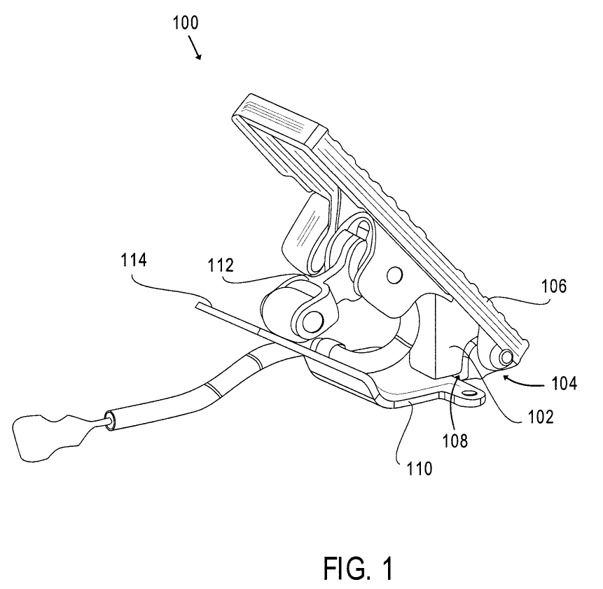

FIG. 1 illustrates an embodiment of a brake pedal assembly 100 in accordance with various embodiments of the present invention. Embodiments of the present invention may include an electronic brake pedal assembly 100 having a unitary resistance member 102 disposed at a pivot point 104 of a pedal 106 with respect to the vehicle. In one embodiment, the resistance member is adapted to fit in an angular cavity 108 defined by the intersection of the pedal with a base plate 110 of the pedal assembly or the floor of the vehicle. The intersection is generally referred to as the pivot point. Various embodiments, however, may be used with other types of pedal arrangements, wherein the pivot point may be positioned at other points along the pedal, or the pivot point may be near a linkage or coupling that couples the pedal to the vehicle.

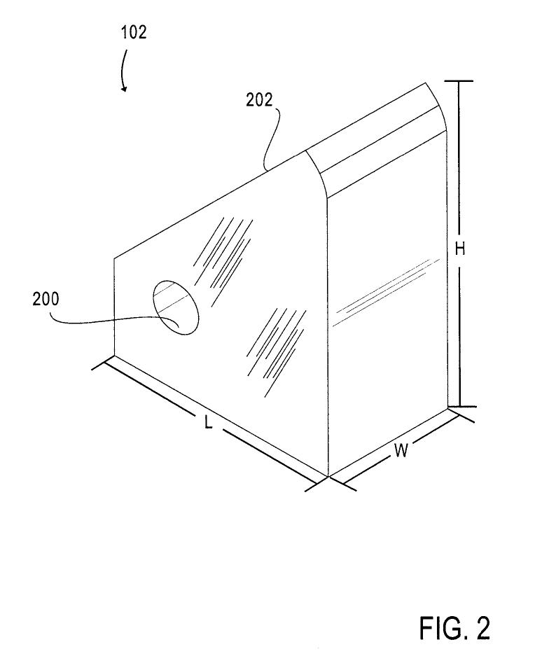

FIG. 2 illustrates an example of a resistance member 102 adapted to augment the resistance force of a pedal assembly in accordance with embodiments of the present invention. The example includes at least one receptacle 200 defined therein that may extend through the member. Alternatively, there may be two receptacles, one on each side of the resistance member. Further, in other embodiments, the member may include other features adapted to assist in coupling the member.

In various embodiments, the resistance member may include an angled surface 202 for engaging, either directly or indirectly, an underside of pedal 106. Example dimensions include an overall height H of approximately 60 millimeters (mm), an overall length L of approximately 46 mm and an overall width of approximately 26 mm. The dimensions and overall shape for resistance member 102 are simply examples and may be altered as desired by one skilled in the art to fit the needs based upon, for example, the size and shape of angular cavity 108 within which the resistance member may be used.

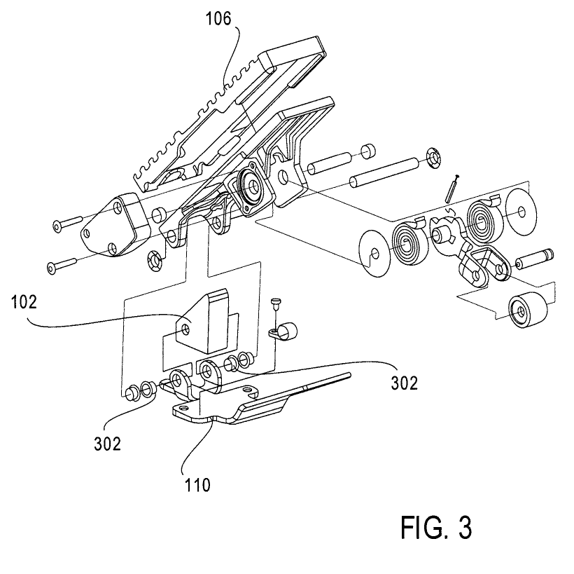

FIG. 3 illustrates an exemplary pedal arrangement in an exploded view that includes resistance member 102. In various embodiments, resistance member 102 may be held in angular cavity 108 by a pivot pin or pins 302 at receptacle or receptacles 200, thereby securing the pedal to base plate 110 or to a vehicle. By placing the resistance member at the pivot point, the resistance member may provide increasing pedal force as the pedal is actuated in a downward direction, thus providing feedback to the user during a braking operation. Being in the angular cavity, the resistance member may not interfere with the other components of the pedal assembly and may be relatively unobtrusive, such that debris and other material will not get hung up in the pedal assembly by way of interference with the resistance member.

In accordance with various embodiments, the resistance member may be made of a one piece rubber or other polymeric and/or elastomeric material. The amount of resistance and the resistance profile may be controlled by modifying the durometer and/or elastic properties of the resistance material. In accordance with various embodiments, a silicone material may be used that may result in the generation of a substantially linear pedal force. In various embodiments, the force may be in the range of approximately 5-75 foot pounds, and in some embodiments, more particularly in the range of 10 to 50 ft-lbs. Also, the resistance may be modified by modifying the size and/or geometry of the resistance material. In accordance with various embodiments, the resistance material may be selected to maintain stable and reliable resistance properties over a wide range of temperatures, and may further be selected to be resistant to agents and chemical compounds that my be encountered.

In accordance with various embodiments of the present invention, a pedal assembly may be provided that includes a pedal having a position sensor coupled thereto and adapted to sense the position of the pedal. The pedal may be pivotally coupled to the vehicle through a base plate 110 and pivot pin or pins 302 and a rolling support 112 may be disposed between the pedal and the base plate to allow supported movement of the pedal about the pivot pin. In such an embodiment, the rolling support engages an engagement surface 114 of the base plate. A resistance member 102 may be disposed at the lower end of the pedal in an angular cavity 108 formed by the intersection of the pedal and the base plate, and may be adapted to provide for an increased pedal resistance force as the pedal is actuated.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A pedal arrangement comprising:
a pedal including a pivot end and pivotally coupled to one of a base plate or a vehicle floor via the pivot end, the pedal and vehicle floor defining a cavity adjacent the pivot end; and
a resistance member generally disposed in the cavity and adapted to affect resistance felt by an operator when moving the pedal.

2. The pedal arrangement of claim 1, wherein the pedal is coupled to one of the base plate or the vehicle floor via at least one pin.

3. The pedal arrangement of claim 1 wherein the resistance member comprises a silicone material.

4. The pedal arrangement of claim 3, wherein when the pedal arrangement is in use, the resistance member imparts a substantially linear pedal force in a range of 5 to 75 ft-lbs.

5. The pedal arrangement of claim 1, further comprising a position sensor operatively coupled to the pedal.

6. The pedal arrangement of claim 1, wherein the resistance member comprises an angled surface that engages the bottom surface of the pedal in order to affect resistance felt by an operator when moving the pedal.

7. The pedal arrangement of claim 6, wherein the angled surface directly engages the bottom surface of the pedal.

8. The pedal arrangement of claim 6, wherein the angled surface indirectly engages the bottom surface of the pedal.

9. The pedal arrangement of claim 1, wherein the pedal arrangement is an electronic brake pedal arrangement.

10. An electronic pedal arrangement comprising:
a base plate comprising a pivot portion and an engagement surface;
a pedal pivotably coupled to the base plate at the pivot portion such that the pedal may pivot relative to the pivot portion;
a roller member operatively coupled to the pedal and engaging the engagement surface such that the pedal and base plate define a cavity adjacent the pivot portion; and
a resistance member within the cavity, the resistance member comprising an angled surface adjacent a bottom surface of the pedal.

11. The pedal arrangement of claim 10, wherein the pedal is coupled to the base plate via at least one pin.

12. The pedal arrangement of claim 10 wherein the resistance member comprises a silicone material.

13. The pedal arrangement of claim 12, wherein when the pedal arrangement is in use, the resistance member imparts a substantially linear pedal force in a range of 10 to 50 ft-lbs.

14. The pedal arrangement of claim 10, further comprising a position sensor operatively coupled to the pedal.

15. The pedal arrangement of claim 10, wherein the angled surface directly engages the bottom surface of the pedal.

16. The pedal arrangement of claim 10, wherein the angled surface indirectly engages the bottom surface of the pedal.

17. The pedal arrangement of claim 10, wherein the pedal arrangement is an electronic brake pedal arrangement.

18. A method comprising:
providing a resistance member within a cavity of a pedal arrangement defined by a pivot point between a pedal and a vehicle; and
engaging, with the pedal, the resistance member during operation of the pedal arrangement to increase resistance applied to the pedal.

19. The method of claim 18, wherein engaging, with the pedal, the resistance member during operation of the pedal arrangement comprises directly engaging the resistance member with the pedal.

20. The method of claim 18, wherein engaging, with the pedal, the resistance member during operation of the pedal arrangement comprises indirectly engaging the resistance member with the pedal.
